(19) United States
(12) Patent Application Publication
(10) Pub. No.: US 2026/0270358 A1
(43) Pub. Date: Sep. 10, 2026

(54) IMAGE READING SYSTEM, IMAGE READING METHOD, READING APPARATUS, AND STORAGE MEDIUM

(71) Applicant: Canon Kabushiki Kaisha, Tokyo (JP)

(72) Inventor: SHUNSUKE MAKI, Tokyo (JP)

(21) Appl. No.: 19/554,762

(22) Filed: Mar. 3, 2026

(30) Foreign Application Priority Data
Mar. 7, 2025 (JP) 2025-036688

(51) Int. Cl. H04N 1/21; H04N 1/00; H04N 1/32; H04N 1/44

(52) U.S. Cl. CPC H04N 1/2166; H04N 1/00209; H04N 1/00236; H04N 1/00244; H04N 1/00891; H04N 1/32101; H04N 1/4413; H04N 1/444; H04N 2201/0081; H04N 2201/0087; H04N 2201/3246; H04N 2201/3249; H04N 2201/3273; H04N 2201/3278

(57) ABSTRACT

An image reading system includes a reading apparatus that reads an original document, a server, and an information terminal. The reading apparatus functions as: a first transmission unit that transmits a scanned image, which is obtained by reading the original document, to the server; and a first saving unit that saves storage destination information including information of a storage location of the scanned image in the server. The information terminal functions as: a first obtaining unit that obtains the storage destination information saved in the first saving unit; and a second obtaining unit that obtains the scanned image from the server based on the storage destination information obtained by the first obtaining unit. The reading apparatus transmits the storage destination information of the scanned image to the information terminal in a case where a request for the storage destination information of the scanned image is received from the information terminal.

### BACKGROUND

### Field of the Technology

The present disclosure relates to an image reading system, an image reading method, a reading apparatus, and a storage medium.

### Description of the Related Art

An image obtainment system configured to download and save a scanned image, which is obtained by reading an original document with a reading apparatus such as a scanner, into an information terminal such as a personal computer (PC) and a smartphone has been known.

Japanese Patent Laid-Open No. 2022-045185 describes a system to download a scanned image obtained by a reading apparatus to a portable information terminal. In the above-described system, the scanned image obtained by the reading apparatus is, first, uploaded to a server, and a URL indicating an upload destination is displayed by the reading apparatus as a two-dimensional code such as a QR code (registered trademark). Then, an image of the QR code is captured and read by the information terminal, and thus it is possible to download a scanned image from the server to the information terminal.

A preferable information terminal in the system described in Japanese Patent Laid-Open No. 2022-045185 is a compact terminal including an image-capturing device such as a camera-equipped smartphone, for example. There is a demand for an improvement of the usability in a case of downloading the scanned image, which is generated by the reading apparatus and uploaded to the server, to the information terminal.

### SUMMARY

An image reading system according to an aspect of the present disclosure is an image reading system, including: a reading apparatus configured to read an original document; a server; and an information terminal, in which the reading apparatus includes at least one memory and at least one processor which function as: a first transmission unit configured to transmit a scanned image, which is obtained by reading the original document, to the server; and a first saving unit configured to save storage destination information including information of a storage location of the scanned image in the server, the information terminal includes at least one memory and at least one processor which function as: a first obtaining unit configured to obtain the storage destination information saved in the first saving unit from the reading apparatus; and a second obtaining unit configured to obtain the scanned image from the server based on the storage destination information obtained by the first obtaining unit, and the reading apparatus transmits the storage destination information of the scanned image to the information terminal in a case where a request for the storage destination information of the scanned image is received from the information terminal.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a schematic overall configuration of an image reading system;

FIG. 2 is a block diagram illustrating an example of a hardware configuration of a reading apparatus;

FIG. 3 is a block diagram illustrating an example of a hardware configuration of an information terminal;

FIG. 4 is a block diagram illustrating an example of a hardware configuration of a server;

FIG. 5 is a sequence diagram illustrating an example of a procedure of an image reading method;

FIG. 6 is a diagram illustrating an example of a service selection screen in the reading apparatus;

FIG. 7 is a diagram illustrating an example of a user selection screen in the reading apparatus;

FIG. 8 is a diagram illustrating an example of a scanning setting screen in the reading apparatus;

FIG. 9 is a diagram illustrating an example of a scanning completion screen in the reading apparatus;

FIG. 10 is a diagram illustrating an example of a dialogue about expiration of time limit in the information terminal;

FIG. 11 is a flowchart illustrating an example of a behavior of the reading apparatus in the image reading method;

FIG. 12 is a flowchart illustrating an example of a behavior of the information terminal in the image reading method;

FIG. 13 is a diagram illustrating an example of a scanning setting window in the information terminal;

FIG. 14 is a diagram illustrating an example of a saving destination display window in the information terminal;

FIG. 15 is a diagram illustrating an example of a saving completion dialogue in the information terminal; and

FIG. 16 is a diagram illustrating an example of an access code display screen in the reading apparatus.

### DESCRIPTION OF THE EMBODIMENTS

Hereinafter, preferable embodiments of the present disclosure are described in detail with reference to the appended drawings. Note that, the following embodiments are not intended to limit the present disclosure according to the scope of claims, and not all the combinations of characteristics described in the present embodiments are necessarily required for the means for solving the problems of the present disclosure.

### First Embodiment

### System Configuration

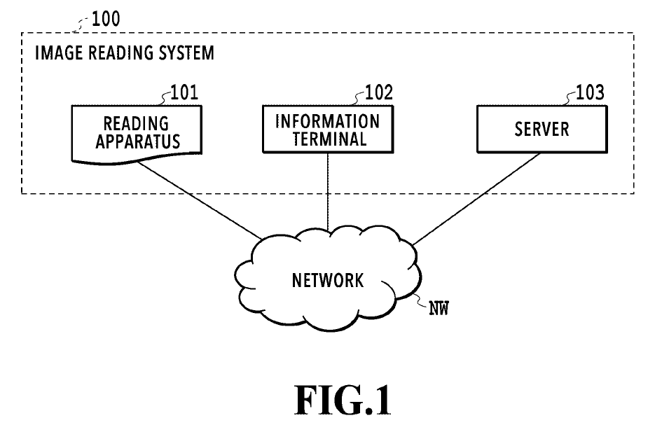

FIG. 1 is a diagram illustrating an example of a schematic overall configuration of an image reading system. An image reading system 100 includes a reading apparatus 101, an information terminal 102, and a server 103. The reading apparatus 101 is an apparatus configured to read an original document. The reading apparatus 101 has a scanning function to generate a scanned image from the read original document and can transmit the scanned image to an external device. The reading apparatus 101 is a Multi Functional Peripheral (MFP) or a scanner, for example. The information terminal 102 is an information processing apparatus such as a personal computer (PC) or a smartphone, for example. The information terminal 102 can obtain and save the scanned image generated by the reading apparatus 101. The server 103 is an information processing apparatus that can save data and transmit and receive the data between the reading apparatus 101 and the information terminal 102.

The reading apparatus 101, the information terminal 102, and the server 103 can communicate with each other. In the present embodiment, the reading apparatus 101, the information terminal 102, and the server 103 are communicably connected to each other via a network NW. The network NW is the Internet or an intranet, for example. The reading apparatus 101, the information terminal 102, and the server 103 may be connected to the network NW via a router and may be connected with the router via a wireless LAN or a wired LAN. In another embodiment, the reading apparatus 101, the information terminal 102, and the server 103 communicate with each other via an interface such as a Universal Serial Bus (USB).

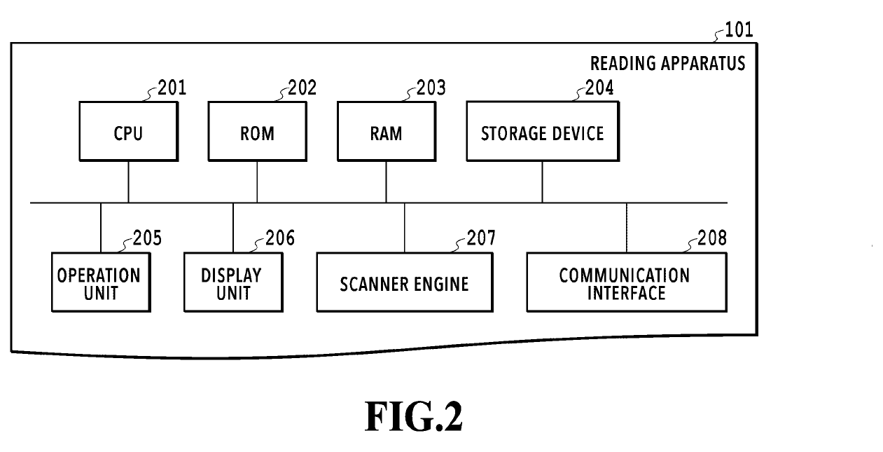

FIG. 2 is a block diagram illustrating an example of a hardware configuration of the reading apparatus. The reading apparatus 101 includes a CPU 201, a ROM 202, a RAM 203, a storage device 204, an operation unit 205, a display unit 206, a scanner engine 207, and a communication interface 208. The above-described constituents of the reading apparatus 101 are all connected to a bus and can communicate with each other.

The CPU 201 performs calculation processing and control of an internal device of the reading apparatus 101. The CPU 201 performs overall control of the reading apparatus 101 by reading out a control program stored in the ROM 202 to the RAM 203 to execute, for example. The ROM 202 is a storage device dedicated for reading out and stores basic software, setting information, and the like to control the reading apparatus 101. The RAM 203 functions as a rasterization region of a program executed by the CPU 201 or a temporal storage region of working data of a program that is in execution. The storage device 204 stores an operating system (OS), application software, and the like. The storage device 204 is a Hard Disk Drive (HDD) or a Solid State Drive (SSD), for example. The storage device 204 may save data such as the scanned image and user setting. The operation unit 205 is an input device configured to accept various instruction operations from a user to the reading apparatus 101 and is a hardware key such as a power button, for example. The display unit 206 is an output device configured to display an image and various types of information to the user and is a liquid crystal monitor, for example. The operation unit 205 and the display unit 206 may be integrally formed as a touch panel. The scanner engine 207 is in charge of a process of generating the scanned image from the original document. For example, once a scanning instruction inputted to the operation unit 205 by the user is transferred to the CPU 201, the CPU 201 instructs the scanner engine 207 to execute scanning. The scanner engine 207 irradiates the original document placed on a not-illustrated platen or an Automatic Document Feeder (ADF) with light and performs conversion into digital data by converting reflected light into an electric signal to generate the scanned image. The communication interface (communication I/F) 208 performs transmission and reception of the data between the reading apparatus 101 and the external device under a protocol such as TCP/IP.

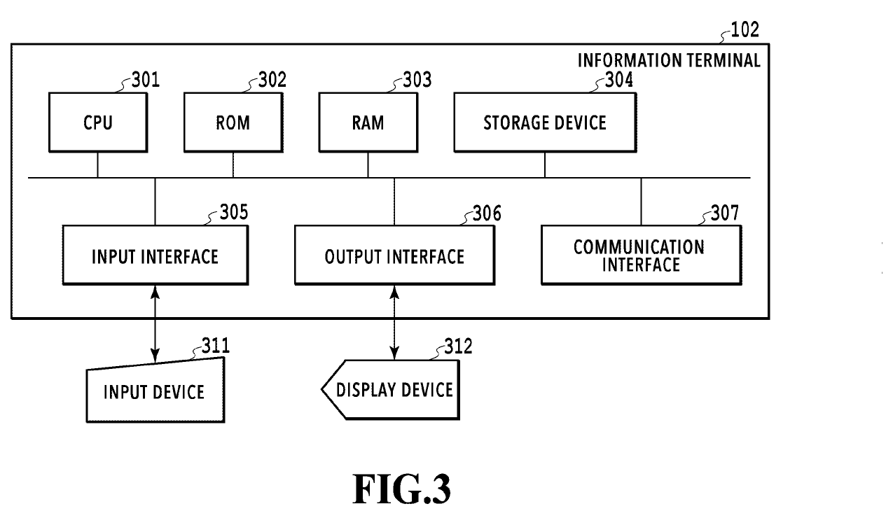

FIG. 3 is a block diagram illustrating an example of a hardware configuration of the information terminal. The information terminal 102 includes a CPU 301, a ROM 302, a RAM 303, a storage device 304, an input interface 305, an output interface 306, and a communication interface 307. The above-described constituents of the information terminal 102 are all connected to a bus and can communicate with each other.

The CPU 301 performs calculation processing and control of an internal device of the information terminal 102. The CPU 301 performs overall control of the information terminal 102 by reading out a control program stored in the ROM 302 to the RAM 303 to execute, for example. The ROM 302 is a storage device dedicated for reading out and stores basic software, setting information, and the like to control the information terminal 102. The RAM 303 functions as a rasterization region of a program executed by the CPU 301 or a temporal storage region of working data of a program that is in execution. The storage device 304 stores an OS, application software, and the like. The storage device 204 is an HDD and an SSD, for example. The input interface (input I/F) 305 inputs a signal from the external device to the information terminal 102. An input device 311 configured to convert an input by the user into a signal may be used by being connected to the input I/F 305. The output interface (output I/F) 306 transmits a signal and data from the information terminal 102 to the external device. An output device configured to output a signal from the information terminal 102 may be used by being connected to the output I/F 306. In the embodiment illustrated in FIG. 3, a display device 312 configured to visually output data from the information terminal 102 is connected to the output I/F 306. The display device 312 may be an external monitor or may be included in the information terminal 102 like a display of a laptop PC. The input device 311 and the display device 312 may be integrally formed as a touch panel, for example. The communication interface (communication I/F) 307 may perform transmission and reception of the data between the reading apparatus 101 and the external device under a protocol such as TCP/IP.

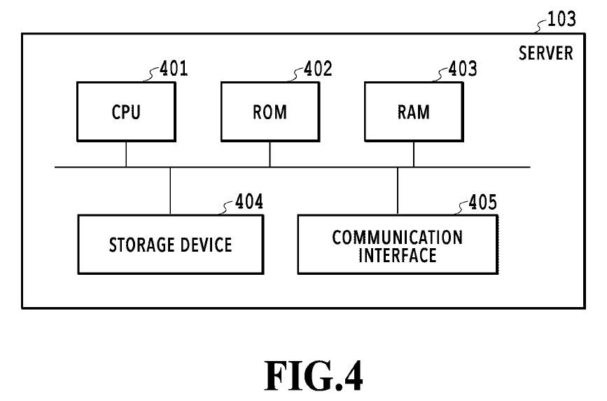

FIG. 4 is a block diagram illustrating an example of a hardware configuration of the server. The server 103 includes a CPU 401, a ROM 402, a RAM 403, a storage device 404, and a communication interface 405. The above-described constituents of the server 103 are all connected to a bus and can communicate with each other.

The CPU 401 performs calculation processing and control of an internal device of the server 103. The CPU 401 performs overall control of the server 103 by reading out a control program stored in the ROM 402 to the RAM 403 to execute, for example. The ROM 402 is a storage device dedicated for reading out and stores basic software, setting information, and the like to control the server 103. The RAM 403 functions as a rasterization region of a program executed by the CPU 401 or a temporal storage region of working data of a program that is in execution. The storage device 404 stores an OS, application software, and the like. The storage device 404 is an HDD or an SSD, for example. The storage device 404 may save an image and a document file, for example. The communication interface (communication I/F) 405 may perform transmission and reception of the data between the server 103 and the external device under a protocol such as TCP/IP.

### Image Reading Method

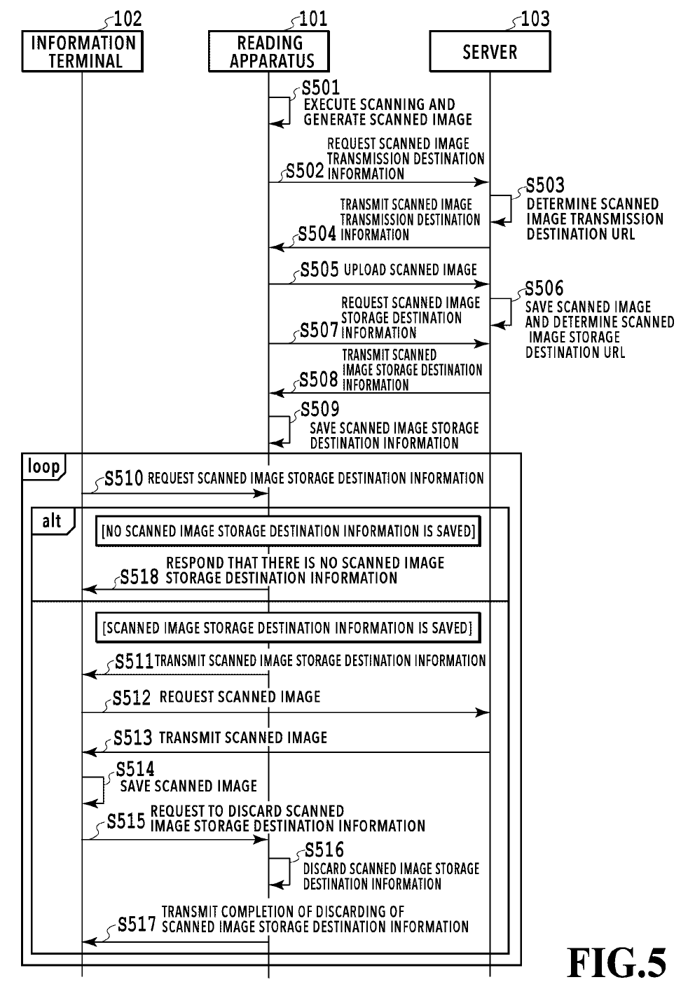

Hereinafter, an image reading method using the image reading system of the present disclosure is described with reference to FIGS. 5 to 15. In the present image reading method, after the scanned image, which is generated from the original document by the reading apparatus 101, is uploaded to the server 103, storage destination information of the scanned image is transferred from the reading apparatus 101 to the information terminal 102, and the information terminal 102 obtains the scanned image from the server 103. The reading apparatus 101 assumed in the present embodiment is an MFP, and the information terminal 102 is a PC. Note that, a part of or all the functions of steps in FIG. 5 may be implemented by hardware such as an ASIC or an electronic circuit. Additionally, a sign "S" in the following descriptions means a step in a sequence diagram or a flowchart.

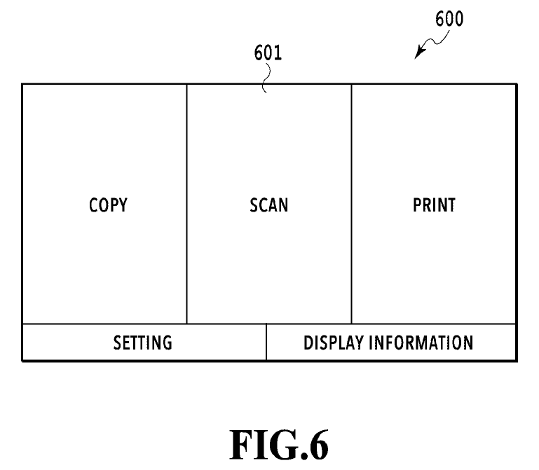

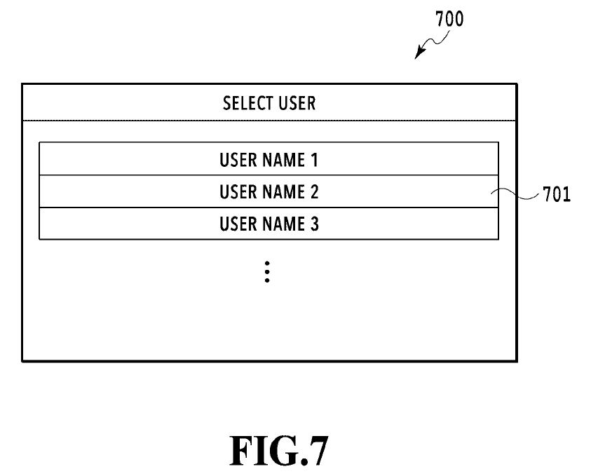

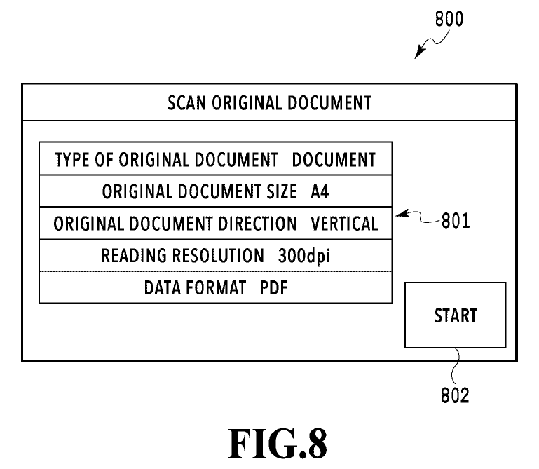

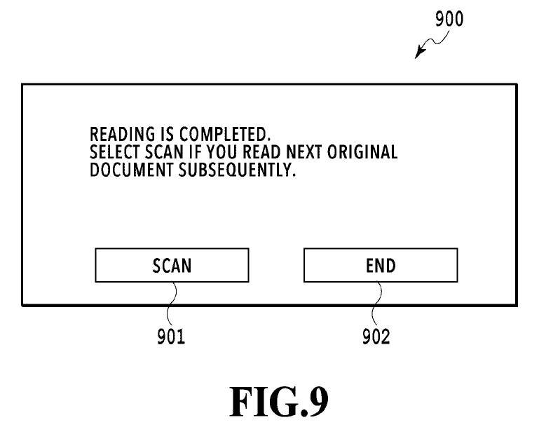

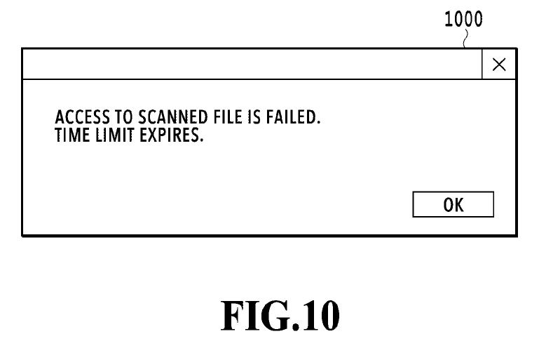

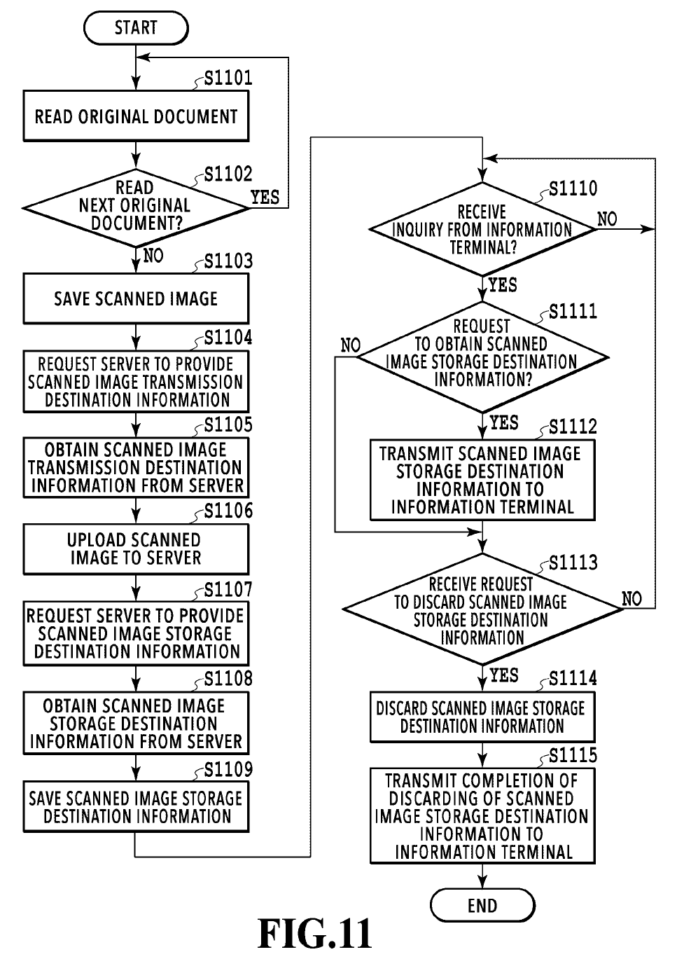

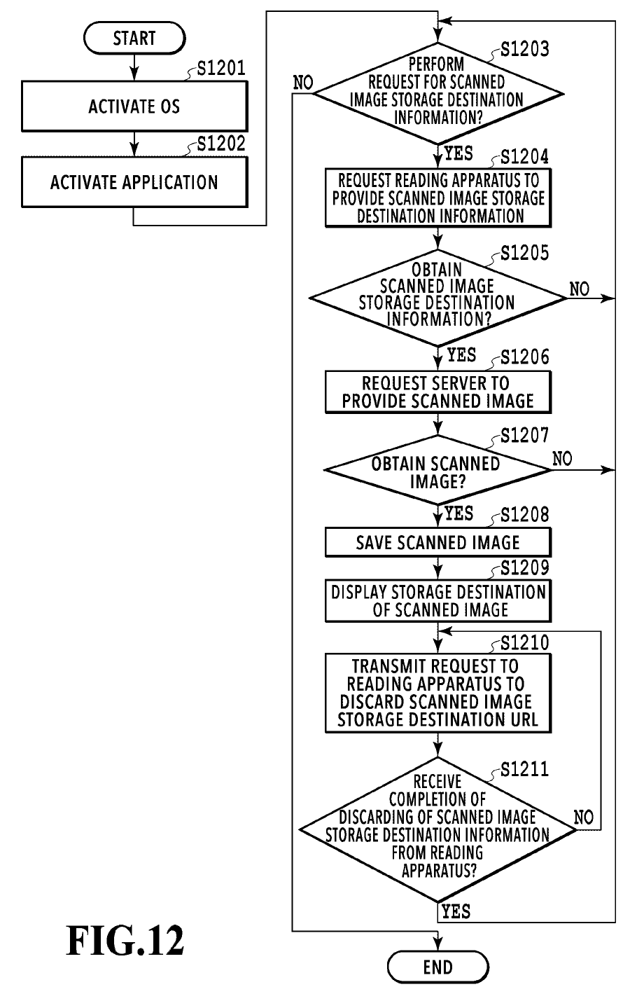

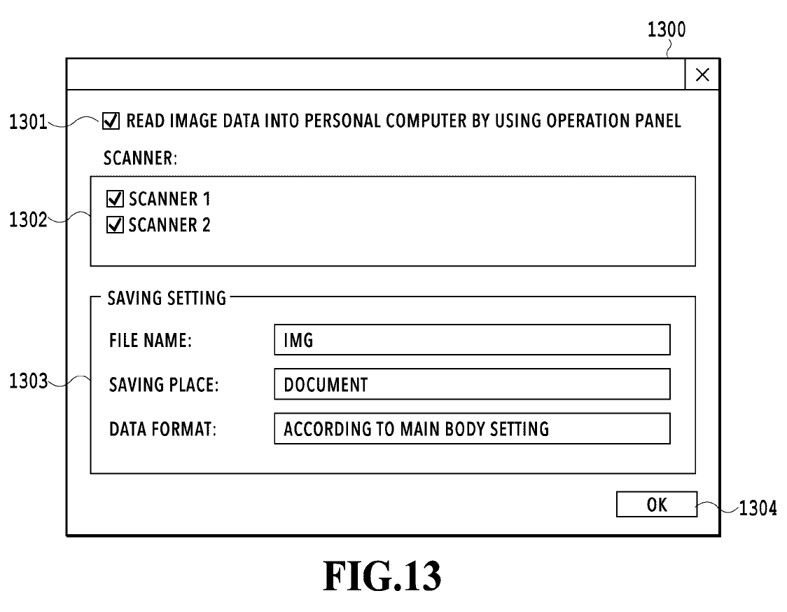

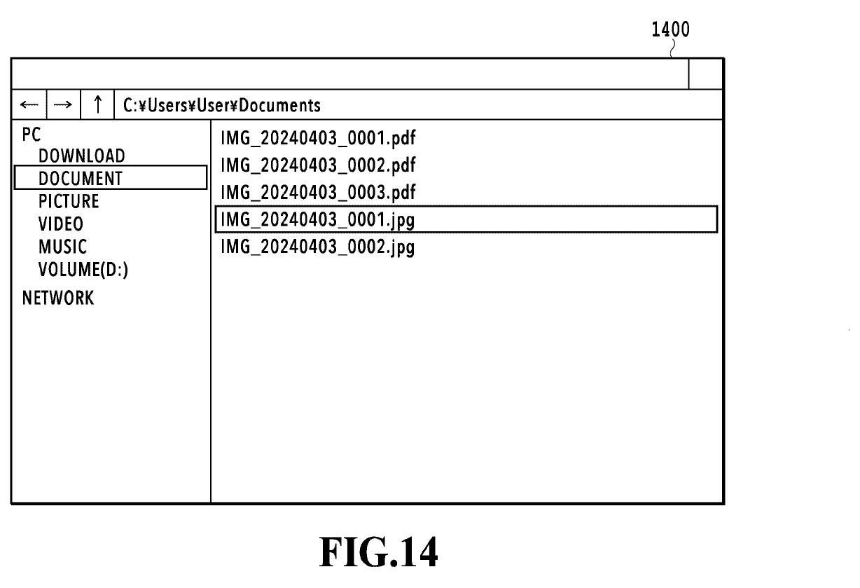

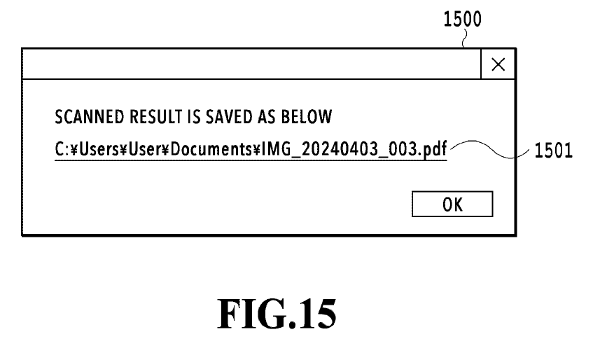

FIG. 5 is a sequence diagram illustrating an example of a procedure of the image reading method. FIG. 6 is a diagram illustrating an example of a service selection screen in the reading apparatus. FIG. 7 is a diagram illustrating an example of a user selection screen in the reading apparatus. FIG. 8 is a diagram illustrating an example of a scanning setting screen in the reading apparatus. FIG. 9 is a diagram illustrating an example of a scanning completion screen in the reading apparatus. FIG. 10 is a diagram illustrating an example of a dialogue about expiration of time limit in the information terminal. FIG. 11 is a flowchart illustrating an example of a behavior of the reading apparatus in the image reading method. FIG. 12 is a flowchart illustrating an example of a behavior of the information terminal in the image reading method. FIG. 13 is a diagram illustrating an example of a scanning setting window in the information terminal. FIG. 14 is a diagram illustrating an example of a saving destination display window in the information terminal. FIG. 15 is a diagram illustrating an example of a saving completion dialogue in the information terminal.

First, the first half of the present image reading method, which is from starting the sequence to uploading the scanned image to the server 103, is described with reference to FIG. 5. For the sake of convenience, descriptions are provided based on an example of starting from an operation by the reading apparatus 101; however, the present disclosure is not limited to the example in FIG. 5 and may be started from an operation by the information terminal 102.

The image reading method illustrated in FIG. 5 is started with the user inputting a scanning execution instruction to the reading apparatus 101. Once the user turns on the reading apparatus 101, a service selection screen 600 is displayed on the display unit 206 as illustrated in FIG. 6. On the service selection screen 600, functions that the reading apparatus 101 can execute are displayed as a list. Once the user presses a scanning button 601 on the service selection screen 600 by operating the operation unit 205, a user selection screen 700 is displayed on the display unit 206 as illustrated in FIG. 7. On the user selection screen 700, user names registered in advance are displayed as a list. Once the user presses one of user name buttons 701 displayed on the user selection screen 700, the selected user is set as a scanning execution user. Thereafter, a scanning setting screen 800 illustrated in FIG. 8 is displayed on the display unit 206.

Note that, the reading apparatus 101 may be set to execute scanning without setting the scanning execution user. In this case, after the scanning button 601 of the service selection screen 600 is pressed, the reading apparatus 101 displays the scanning setting screen 800 on the display unit 206 instead of the user selection screen 700.

On the scanning setting screen 800, a setting item 801 such as a type of the original document including a document and a photograph, an original document size, a reading direction of the original document, a reading resolution, and a data format of the scanned image is displayed. The setting item 801 can be changed by the user, and JPEG, PNG, PDF, and the like can be selected as a data format, for example. As the setting item 801, an item other than the items described above may be settable.

Once the user presses a start button 802 of the scanning setting screen 800, the scanning execution instruction is inputted to the reading apparatus 101, and the sequence illustrated in FIG. 5 starts.

In S501, the reading apparatus 101 generates the scanned image by reading the original document. Once detecting the input of the scanning execution instruction by the user, the reading apparatus 101 starts reading the original document based on the setting item 801 on the scanning setting screen 800.

After reading the original document, the reading apparatus 101 displays a scanning completion screen 900 illustrated in FIG. 9 on the display unit 206. On the scanning completion screen 900, a confirmation message to confirm whether to read the next original document sequentially is displayed. In a case where there is a next original document, the user places the next original document on the platen or the ADF and then presses a scanning continue button 901 on the scanning completion screen 900. After completing reading of all the original documents, the user presses an end button 902. Once the end button 902 is pressed, the reading apparatus 101 generates the scanned image from the read original document and saves the scanned image into the reading apparatus 101. The scanned image may be saved into the RAM 203. In this process, information of the scanning execution user and scanning setting information set by the setting item 801 on the scanning setting screen 800 may be saved in association with the scanned image. The information of the scanning execution user may include a user name and a password.

Note that, the reading apparatus 101 may temporarily save the scanned image in a format different from the data format set by the scanning setting screen 800 depending on processing such as image processing and data transfer. For example, it is assumed that the user performs setting on the scanning setting screen 800 so as to save the scanned image in a PDF format. In this case, the scanned image may be temporarily saved into the RAM 203 in a JPEG format, downloaded to the information terminal 102 by way of the server 103, and then converted into the PDF format on the information terminal 102.

In S502, the reading apparatus 101 requests the server 103 to prepare a place as an upload destination of the scanned image and provide scanned image transmission destination information including information of the upload destination. With the request for the scanned image transmission destination information, the reading apparatus 101 may transmit reading apparatus-related information (a device name, serial number, and so on unique to a device) and a job ID to uniquely identify the executed scanning to the server 103.

In the present embodiment, the information of the upload destination of the scanned image is represented by a Uniform Resource Locator (URL). This URL is called a scanned image transmission destination URL. The scanned image transmission destination URL includes a host name and a domain name (or an IP address) of the server 103 and a path indicating a specific directory in the server 103.

Note that, Hypertext Transfer Protocol Secure (HTTPS) may be used for the communication between the reading apparatus 101 and the server 103.

In S503, the server 103 determines the scanned image transmission destination URL. In the present embodiment, the storage device 404 of the server 103 stores a program to determine the scanned image transmission destination URL. Once the server 103 receives the request for the scanned image transmission destination information from the reading apparatus 101, the CPU 401 of the server 103 reads out the program to determine the scanned image transmission destination URL from the storage device 404 to execute. In this case, the server 103 may create a directory associated with the reading apparatus-related information, the job ID, and the like received in S502 and determine the directory as the upload destination of the scanned image.

In S504, the server 103 transmits the scanned image transmission destination information including the scanned image transmission destination URL to the reading apparatus 101. The reading apparatus 101 may save the obtained scanned image transmission destination information into the RAM 203.

Note that, the scanned image transmission destination URL may be determined by the reading apparatus 101. In this case, S502 to S504 are not executed.

In S505, the reading apparatus 101 uploads the scanned image to the scanned image transmission destination URL received in S504.

In S506, the server 103 determines a storage location of the uploaded scanned image and saves the scanned image. In the present embodiment, the uploaded scanned image is transferred to a directory different from the upload destination. The final saving destination of the scanned image is represented by a URL, and this URL is called a scanned image storage destination URL. The scanned image storage destination URL includes the host name and the domain name (or the IP address) of the server 103, the path indicating the specific directory in the server 103, and the like. Additionally, in the present embodiment, the storage device 404 of the server 103 stores a program to determine the scanned image storage destination URL. After the scanned image is uploaded, the CPU 401 of the server 103 reads out the program to determine the scanned image storage destination URL from the storage device 404 to execute.

Note that, the scanned image transmission destination URL and the scanned image storage destination URL may be the same. In this case, the subsequent steps, S507 and S508, may not be executed.

In S507, the reading apparatus 101 requests the server 103 to provide the scanned image storage destination information including the scanned image storage destination URL. In this process, the reading apparatus 101 may transmit the scanned image transmission destination information and a file name of the scanned image to the server 103 while requesting the scanned image storage destination information. S507 may be executed simultaneously with S505 or may be executed after S505. S507 may be executed before S506.

In S508, the server 103 transmits the scanned image storage destination information to the reading apparatus 101. An accessible period of time may be set as time limit in the scanned image storage destination URL, and the time limit may be included in the scanned image storage destination information and transmitted to the reading apparatus 101. As the time limit, a predetermined period of time from a time point at which the scanned image storage destination information is transmitted from the server 103 may be set. The time limit is ten minutes, for example.

The scanned image storage destination information may include the reading apparatus-related information, the job ID, the file name of the scanned image, and the like, and those pieces of information may be used as authentication information in the communication between the reading apparatus 101 and the server 103.

In S509, the reading apparatus 101 saves the scanned image storage destination information including the information of the storage location of the scanned image. The reading apparatus 101 saves the scanned image storage destination information including the scanned image storage destination URL into the RAM 203 or the storage device 204. The reading apparatus 101 may save the scanned image storage destination information in association with the information of the scanning execution user, the scanning setting information, the scanned image, and the like.

At this point, storing of the scanned image into the server 103 is completed.

The reading apparatus 101 can execute reading of the original document and saving of the scanned image storage destination information described above regardless of an activation state of the information terminal 102. The activation state of the information terminal 102 indicates whether the power of the information terminal 102 is ON or OFF and whether it is a state of being able to communicate with the reading apparatus 101. In other words, the reading apparatus 101 and the server 103 can execute the above-described processing from S501 to S509 without communicating with the information terminal 102.

Note that, S501 to S509 may be executed repeatedly to store multiple files of the scanned image into the server 103. Alternatively, in parallel with the steps from S502 to S509 in which a scanned image SI is stored into the server 103, S501' in which a scanned image SI' is generated as another file and S502' to S509' in which the scanned image SI' is stored into the server 103 may be executed.

The RAM 203 or the storage device 204 may save multiple pieces of the scanned image storage destination information corresponding to the multiple scanned image files.

Additionally, although the server storing the programs to determine the scanned image transmission destination URL and the scanned image storage destination URL and the server storing the scanned image data are the same in the present embodiment, the servers may be different.

From now, the latter half of the present image reading method (in and after S510) is described.

Before starting S510 in FIG. 5, the information terminal 102 is in a state of being able to communicate with the reading apparatus 101 and the server 103 in which the OS is activated, and a scanning application corresponding to the reading apparatus 101 is activated. The activation of the OS and the scanning application may be executed at an arbitrary timing before starting S510 and may be executed after S509 is completed.

In S510, the information terminal 102 requests the reading apparatus 101 to provide the scanned image storage destination information. The information terminal 102 may repeatedly execute the requesting of the scanned image storage destination information on a regular basis. An interval of transmitting the request is arbitrary. In this case, with the request for the scanned image storage destination information, the information terminal 102 may transmit information of the user operating the information terminal 102 to the reading apparatus 101.

Incidentally, in a case of executing S510, the reading apparatus 101 may operate in a sleep mode in which power is partially off while maintaining the working state. In a case where the scanned image storage destination information is saved in the reading apparatus 101, the reading apparatus 101 may receive the signal from the information terminal 102 and responds even in the sleep mode. Also in the sleep mode, the communication I/F 208 is in an operating state, and thus it is possible to receive the signal from the information terminal 102 and respond.

Additionally, the reading apparatus 101 may have an auto-power-off function to be turned off automatically in a case where a predetermined time has elapsed with no operations. In a case where the scanned image storage destination information is saved in the reading apparatus 101, the reading apparatus 101 may receive the signal from the information terminal 102 and respond without executing auto-power-off. That is, auto-power-off may be disabled temporarily. In addition, the reading apparatus 101 may execute auto-power-off after discarding the scanned image storage destination information. That is, after the scanned image storage destination information is discarded, the reading apparatus 101 may enable auto-power-off again, which has been temporarily disabled. Discarding of the scanned image storage destination information is described later.

With the control as described above, even in a case where the scanned image storage destination information is saved in a volatile memory, it is possible to prevent the deletion of the scanned image storage destination information caused by the stop of the power supply.

After the reading apparatus 101 receives the request for the scanned image storage destination information in S510, if the scanned image storage destination information is saved in the reading apparatus 101, the reading apparatus 101 executes S511, and if not saved, the reading apparatus 101 executes S518. A flow from S511 is described first, and S518 is described later.

In S511, if the request for the scanned image storage destination information is received from the information terminal 102 in S510, the reading apparatus 101 transmits the scanned image storage destination information to the information terminal 102. The reading apparatus 101 may transmit the scanning setting information to the information terminal 102 with the scanned image storage destination information.

In a case of receiving the request for the scanned image storage destination information, the reading apparatus 101 may transmit the scanned image storage destination information to the information terminal 102 if the user authentication succeeds. Specifically, in a case where the information of the user operating the information terminal 102 that is received in S510 and the information of the scanning execution user associated with the scanned image storage destination information match, the reading apparatus 101 transmits the scanned image storage destination information to the information terminal 102. If the two pieces of user information do not match, the reading apparatus 101 may transmit a response indicating a user authentication error to the information terminal 102. The information of the user used in this user authentication is the user name, for example.

In S512, the information terminal 102 requests the server 103 to provide the scanned image. The information terminal 102 designates the scanned image storage destination URL included in the scanned image storage destination information obtained in S511 and transmits the request for the scanned image to the server 103. The information terminal 102 may access the server 103 by way of an Application Programming Interface (API). Alternatively, the information terminal 102 may access the server 103 by way of a Web browser activated by the scanning application. Note that, the reading apparatus 101 may save multiple pieces of the scanned image storage destination information, and in S511, the reading apparatus 101 may transmit the multiple pieces of the scanned image storage destination information to the information terminal 102 all at once. In S512, the information terminal 102 may request the server 103 to provide multiple scanned images corresponding to multiple scanned image storage destination URLs simultaneously.

In S513, the server 103 transmits the scanned image to the information terminal 102. Once receiving the request for the scanned image, the server 103 transmits the scanned image to the information terminal 102. Note that, in a case where the timing at which the information terminal 102 accesses the server 103 in S512 exceeds the time limit set in the scanned image storage destination URL, the server 103 may transmit information indicating the expiration of the time limit to the information terminal 102. In this case, the information terminal 102 may display a dialogue 1000 about the expiration of the time limit illustrated in FIG. 10 on the display device 312.

The information terminal 102 may output the obtained scanned image via the output interface 306. The information terminal 102 may display the scanned image on the display device 312 via the output interface 306 or may display the scanned image on the display device 312 integrally formed with the output interface 306.

In S514, the information terminal 102 saves the obtained scanned image. The information terminal 102 may automatically save the scanned image into a place set by the scanning application (details are described later). Alternatively, the information terminal 102 may automatically save the scanned image into the place set by the scanning setting screen 800 of the reading apparatus 101. In another embodiment, first, the information terminal 102 displays the scanned image obtained by way of the Web browser on the Web browser and then saves the scanned image according to an operation by the user on the Web browser. In yet another embodiment, first, the information terminal 102 displays the obtained scanned image on a UI of the scanning application and then saves the scanned image according to an operation by the user on the scanning application.

In S515, the information terminal 102 requests the reading apparatus 101 to discard the scanned image storage destination information. With the deletion of the scanned image storage destination information from the reading apparatus 101, it is possible to reduce a possibility of the occurrence of unauthorized access to the server 103 because the scanned image storage destination information is passed to a third party.

After the successful obtainment of the scanned image from the server 103, the information terminal 102 instructs the reading apparatus 101 to discard the scanned image storage destination information. With the request to discard the scanned image storage destination information, the information terminal 102 may transmit the information of the user operating the information terminal 102 to the reading apparatus 101.

Note that, the information terminal 102 may automatically instruct the reading apparatus 101 to discard the scanned image storage destination information after the time limit in the scanned image storage destination URL expires regardless of whether the scanned image is obtained. Additionally, in a case where the information terminal 102 obtains the multiple scanned images from the server 103, the information terminal 102 may request discarding of the scanned image storage destination information corresponding to the multiple scanned images all at once or may request discarding of only the scanned image storage destination information selected by the user. In the latter case, the information terminal 102 displays a list of the obtained scanned images or the file names of the scanned images on the UI of the scanning application and instructs the reading apparatus 101 to discard only the scanned image storage destination information of the scanned image selected by the user.

In S516, the reading apparatus 101 executes discarding of the scanned image storage destination information. In a case where the request to discard the scanned image storage destination information is received from the information terminal 102, the reading apparatus 101 discards the scanned image storage destination information saved in the reading apparatus 101. The reading apparatus 101 may automatically discard the scanned image storage destination information according to the transmission of the scanned image storage destination information to the information terminal 102 in S511. Alternatively, the reading apparatus 101 may discard the scanned image storage destination information only in a case where the information of the user operating the information terminal 102 received in S515 matches the information of the scanning execution user associated with the scanned image storage destination information that is a discarding target.

In S517, the reading apparatus 101 transmits completion of discarding of the scanned image storage destination information to the information terminal 102. If the completion of discarding is not received from the reading apparatus 101 within a predetermined time after the information terminal 102 transmits the request to discard the scanned image storage destination information in S516, the information terminal 102 may execute S516 again.

After S517, the information terminal 102 executes S510 again. If the scanned image storage destination information is saved in the reading apparatus 101, the reading apparatus 101 executes S511 again, and if not saved, the reading apparatus 101 executes S518.

In S518, the reading apparatus 101 transmits a response indicating that there is no scanned image storage destination information saved to the request for the scanned image storage destination information from the information terminal 102. Thereafter, the information terminal 102 executes S510 again.

In the sequence diagram illustrated in FIG. 5, the information terminal 102 repeats S510 to S518 until the request for the scanned image storage destination information from the information terminal 102 is stopped by an operation on an information terminal 102 side. Stopping the request for the scanned image storage destination information is described later.

Note that, the scanned image stored in the server 103 may also be automatically deleted from the server 103 after a predetermined period of time has elapsed. The predetermined period of time may be the same as the time limit in the scanned image storage destination URL.

Subsequently, operations of the reading apparatus 101 and the information terminal 102 in the present image reading method are described in detail with reference to FIGS. 11 and 12.

First, the operation of the reading apparatus 101 is described with reference to FIG. 11. Once the scanning execution instruction is inputted, the reading apparatus 101 starts the flowchart illustrated in FIG. 11.

In S1101, the CPU 201 of the reading apparatus 101 performs reading of the original document. S1101 corresponds to S501.

In S1102, the CPU 201 determines whether to read the next original document. Once the scanning continue button 901 on the scanning completion screen 900 illustrated in FIG. 9 is pressed by the operation by the user, the CPU 201 executes S1101 again (YES in S1102). Once the end button 902 on the scanning completion screen 900 is pressed by the operation by the user, the CPU 201 allows the process to proceed to S1103 (NO in S1102).

In S1103, the CPU 201 saves the scanned image. In S1104, the CPU 201 requests the server 103 to provide the scanned image transmission destination information. S1104 corresponds to S502. In S1105, the CPU 201 receives the scanned image transmission destination information from the server 103. S1105 corresponds to S504. In S1106, the CPU 201 uploads the scanned image to the server 103. S1106 corresponds to S505. In S1107, the CPU 201 requests the server 103 to provide the scanned image storage destination information. S1107 corresponds to S507. In S1108, the CPU 201 receives the scanned image storage destination information from the server 103. S1108 corresponds to S508. In S1109, the CPU 201 saves the scanned image storage destination information. S1109 corresponds to S509.

In S1110, the CPU 201 determines whether an inquiry from the information terminal 102 is received. If it is determined as YES, the process proceeds to S1111, and if it is determined as NO, S1110 is executed again.

In S1111, the CPU 201 determines whether the inquiry from the information terminal 102 received in S1110 is the request to obtain the scanned image storage destination information. If it is determined as YES, the process proceeds to S1112, and if it is determined as NO, the process proceeds to S1113.

In S1112, the CPU 201 transmits the scanned image storage destination information to the information terminal 102. S1112 corresponds to S511.

In S1113, the CPU 201 determines whether the request to discard the scanned image storage destination information is received from the information terminal 102. If it is determined as YES, the process proceeds to S1114, and if it is determined as NO, the process proceeds to S1110.

In S1114, the CPU 201 executes discarding of the scanned image storage destination information. S1114 corresponds to S516.

In S1115, the CPU 201 transmits the completion of discarding of the scanned image storage destination information to the information terminal 102. S1115 corresponds to S517.

With the above, the CPU 201 ends the processing in the flowchart illustrated in FIG. 11.

Note that, although the operation of the reading apparatus 101 is described as a sequence of flowchart for the sake of convenience, S1101 to S1109 and S1110 to S1115 in FIG. 11 may be divided as different flows. In this case, a trigger to start S1110 may be turning on the reading apparatus 101.

In the above descriptions, various controls described to be performed by the CPU 201 may be performed by a single piece of hardware, or multiple pieces of hardware (for example, multiple processors or circuits) may perform control of the overall apparatus by sharing the processing.

Next, regarding the information terminal 102, the scanning application that is software to control the reading apparatus 101 from the information terminal 102 is described first, and subsequently, the operation of the information terminal 102 in the present image reading method is described with reference to FIG. 12.

The scanning application corresponding to the reading apparatus 101 is installed in advance in the information terminal 102. In a case where the scanning application is set to be automatically activated in a case of OS activation, the CPU 301 operates the scanning application in the background without displaying the UI of the scanning application and keeps the scanning application in a task tray or the like that is a function of the OS such as Windows. Once the user selects an icon of the scanning application on the task tray, the CPU 301 displays a scanning setting window 1300 illustrated in FIG. 13 on the display device 312. In a case where the scanning application is not set to be automatically activated in a case of OS activation, the CPU 301 may activate the scanning application by detecting the operation of the input device 311 by the user, for example. Note that, after the scanning application is temporarily interrupted because of user logoff, sleep, or the like of the OS, the CPU 301 resumes the scanning application by user login, waking up from sleep, or the like of the OS.

The scanning setting window 1300 is a screen to perform setting of scanning executed by the reading apparatus 101 from the information terminal 102. A checkbox 1301, a list 1302, a setting item 1303, and an OK button 1304 are displayed on the scanning setting window 1300.

As for the checkbox 1301, a sentence such as "read image data into personal computer by using operation panel" is displayed. Once the OK button 1304 is pressed in a state in which the checkbox 1301 is checked, it is possible to take the scanned image into the information terminal 102 by operating the operation unit 205 of the reading apparatus 101 registered on the scanning application. Once a pressing operation of the OK button 1304 is accepted in a state in which the checkbox 1301 is checked, the information terminal 102 requests the reading apparatus 101 to provide the scanned image storage destination information on a regular basis. That is, the information terminal 102 performs polling processing to obtain the scanned image storage destination information. Note that, the checkbox 1301 may be in the checked state by default.

The list 1302 is a list of the reading apparatus 101 registered on the scanning application. Multiple reading apparatuses 101 may be registered on the scanning application. A checkbox is arranged next to a device name of each reading apparatus 101 in the list 1302, and the reading apparatus 101 with the checked checkbox can take the scanned image into the information terminal 102 by operating the operation unit 205. The list 1302 may be in a state in which all the checkboxes next to the device names of the reading apparatuses 101 are checked by default.

The setting item 1303 in a case of saving the scanned image into the information terminal 102 is displayed on the scanning setting window 1300. The setting item 1303 is the file name of the scanned image, the saving place in the information terminal 102, the data format, and the like. As the data format, it may be possible to select JPEG, PNG, PDF, and the like, for example, and it may also be possible to select contents "according to main body setting," which indicates that the data format is selected according to the scanning setting on the scanning setting screen 800 of the reading apparatus 101. As the setting item 1303, it may be possible to set an item other than the items illustrated in FIG. 13.

The checkbox 1301, the list 1302, and the setting item 1303 can be selected by the user. Once the user presses the OK button 1304, the setting contents on the scanning setting window 1300 are saved into the information terminal 102.

Note that, as the setting item 1303 of the scanning setting, a unique setting value that cannot be selected by the user may be used. Alternatively, as the setting item 1303, the scanning application may use the setting value obtained from a file or the like in which the setting value is written.

The flowchart illustrated in FIG. 12 is executed by using the scanning application as described above. Once the information terminal 102 is turned on, the information terminal 102 starts the present flowchart.

In S1201, the CPU 301 of the information terminal 102 activates the OS.

In S1202, the CPU 301 activates the scanning application. As described above, the scanning application may be set to be automatically activated in a case of OS activation or may be manually activated by the operation by the user. Once the scanning setting window 1300 is displayed, the user performs setting of the checkbox 1301, the list 1302, and the setting item 1303 and presses the OK button 1304.

Note that, it depends on the user to determine which to perform first: the pressing operation of the OK button 1304 on the scanning setting window 1300 of the information terminal 102 or the reading of the original document by the reading apparatus 101. As illustrated in the sequence diagram in FIG. 5, there may be a case where the reading of the original document by the reading apparatus 101 is performed first, or there may be a case where the pressing operation of the OK button 1304 on the information terminal 102 side is performed first. Since the pressing operation of the OK button 1304 in the information terminal 102 may be performed first, the sentence such as "read image data into personal computer by using operation panel" is displayed with the checkbox 1301.

In S1203, the CPU 301 determines whether setting is performed so as to request the scanned image storage destination information. If it is determined as YES, the CPU 301 allows the process to proceed to S1204, and if it is determined as NO, the CPU 301 ends the processing of the present flowchart. The CPU 301 determines as YES in a case where, specifically, the checkbox 1301 on the scanning setting window 1300 is checked, and also the checkboxes of one or more reading apparatuses 101 are checked on the list 1302 of the reading apparatus 101. The CPU 301 determines as NO in a case where the checkbox 1301 is unchecked, or in a case where none of the checkboxes of the reading apparatuses 101 on the list 1302 is checked.

In S1204, the CPU 301 transmits the request for the scanned image storage destination information to the reading apparatus 101. S1204 corresponds to S510. The CPU 301 requests the reading apparatus 101 with the checked checkbox on the list 1302 of the reading apparatus 101 to provide the scanned image storage destination information. The CPU 301 may execute S1204 for the multiple reading apparatuses 101 in parallel.

In S1205, the CPU 301 determines whether the scanned image storage destination information is obtained. If it is determined as YES, the CPU 301 allows the process to proceed to S1206, and if it is determined as NO, the process proceeds to S1203.

In S1206, the CPU 301 requests the server 103 to provide the scanned image. S1206 corresponds to S512.

In S1207, the CPU 301 determines whether the scanned image is obtained from the server 103. If it is determined as YES, the CPU 301 allows the process to proceed to S1208, and if it is determined as NO, the process proceeds to S1203.

In S1208, the CPU 301 saves the scanned image. S1208 corresponds to S514. The CPU 301 saves the obtained scanned image according to the file name, the saving place, the data format, and the like set by the setting item 1303 on the scanning setting window 1300. Alternatively, as described above, the CPU 301 may save the scanned image into the place set by the scanning setting screen 800 of the reading apparatus 101.

In S1209, the CPU 301 displays the storage location of the scanned image on the display device 312. In an embodiment illustrated in FIG. 14, the CPU 301 displays a saving destination display window 1400 on the display device 312 after the scanned image is saved. On the saving destination display window 1400, the file name of the saved scanned image and a path of the directory of the saving destination of the scanned image are displayed. In an embodiment illustrated in FIG. 15, after the saving of the scanned image is completed, the CPU 301 displays a saving completion dialogue 1500 notifying of the completion of saving on the display device 312. In the saving completion dialogue 1500, scanned image saving destination information 1501 represented by the path of the directory of the saving destination of the scanned image and the file name of the scanned image is displayed. A link may be set in the scanned image saving destination information 1501, and the CPU 301 may launch an image display application by detecting a click of the scanned image saving destination information 1501 and display the scanned image on the display device 312.

In S1210, the CPU 301 transmits the request to the reading apparatus 101 to discard the scanned image storage destination information. S1210 corresponds to S515.

In S1211, the CPU 301 determines whether the completion of discarding of the scanned image storage destination information is received from the reading apparatus 101. If it is determined as YES, the CPU 301 allows the process to proceed to S1203, and if it is determined as NO, the process proceeds to S1210.

As described above, the present flowchart ends if it is determined as NO in S1203.

In S1203, the CPU 301 performs determination based on the setting on the scanning setting window 1300. Once the checkbox 1301 on the scanning setting window 1300 is unchecked by the operation by the user, and the OK button 1304 is pressed, the CPU 301 stops the periodical inquiries to the reading apparatus 101 and stops the present flowchart. Alternatively, the CPU 301 may end the present flowchart in a case where the scanning application ends by the user operation or may end the present flowchart in a case where there is no response from the reading apparatus 101 after a predetermined period of time has elapsed from the periodical inquiry transmission.

Note that, in the above descriptions, various controls described to be performed by the CPU 301 may be performed by a single piece of hardware, or multiple pieces of hardware (for example, multiple processors or circuits) may perform control of the overall apparatus by sharing the processing.

As described above, according to the present embodiment, it is possible to improve the usability in a case of downloading the image, which is scanned by the reading apparatus 101 and uploaded to the server 103, to the information terminal 102. For example, the communication between the reading apparatus 101 and the information terminal 102 in a case of executing scanning by the reading apparatus 101 is unnecessary, and for this reason, it is possible to execute scanning by the reading apparatus 101 even in a case where the information terminal 102 is in a power-off state. In addition, the information terminal 102 applicable to the present embodiment does not need to be a compact terminal including an image-capturing device configured to read a two-dimensional code, for example, and various information terminals 102 may be applicable.

### Second Embodiment

A second embodiment is different from the first embodiment in that, in the image reading method illustrated in FIG. 5, the reading apparatus 101 displays an access code to access the storage destination of the scanned image. Hereinafter, the different point of the second embodiment from the first embodiment is described.

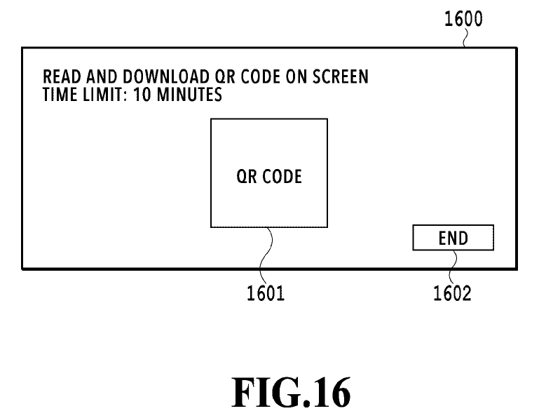

FIG. 16 is a diagram illustrating an example of an access code display screen in the reading apparatus. Once obtaining the scanned image storage destination information from the server 103, the reading apparatus 101 displays an access code 1601 to access the storage destination of the scanned image on the display unit 206. In S509 in FIG. 5, the reading apparatus 101 saves the scanned image storage destination information into the reading apparatus 101 and also displays an access code display screen 1600 on which the access code 1601 is displayed on the display unit 206.

In the present embodiment, the access code 1601 is represented by a two-dimensional code. The reading apparatus 101 may display the access code 1601 on the display unit 206 by converting the scanned image storage destination URL transmitted from the server 103 into the access code 1601. Alternatively, the server 103 may convert the scanned image storage destination URL into an image of the access code 1601 and transmit the image of the access code 1601 to the reading apparatus 101, and the reading apparatus 101 may display the image. In this case, the reading apparatus 101 may convert the access code 1601 into a URL and save the URL as the scanned image storage destination URL into the reading apparatus 101. In addition, the server 103 may transmit both the scanned image storage destination URL and image of the access code 1601 converted from the scanned image storage destination URL to the reading apparatus 101.

The information terminal 102 can obtain the scanned image stored in the server 103 by reading the access code 1601. The information terminal 102 assumed in the second embodiment is a portable terminal including an image-capturing device such as a smartphone and a tablet. Once the user captures an image of the access code 1601 by the image-capturing device of the information terminal 102, the information terminal 102 extracts the scanned image storage destination information from the access code 1601. In this case, the information terminal 102 does not need to include a dedicated scanning application corresponding to the reading apparatus 101 to obtain the scanned image storage destination information. The information terminal 102 accesses the server 103 by designating the scanned image storage destination URL and requests the scanned image. The server 103 transmits the scanned image according to the request from the information terminal 102, and the information terminal 102 saves the received scanned image by the operation by the user.

In a case where the information terminal 102 is the portable terminal, the request to the reading apparatus 101 to discard the scanned image storage destination information may not be transmitted. For this reason, the reading apparatus 101 may automatically discard the scanned image storage destination information after a predetermined time has elapsed after the scanned image storage destination information is obtained. The predetermined time may be the time limit set in the scanned image storage destination URL. Alternatively, the reading apparatus 101 may discard the scanned image storage destination information with the user pressing an end button 1602 displayed on the access code display screen 1600.

According to the present embodiment, the information terminal 102 can obtain the scanned image storage destination information from the reading apparatus 101 by two methods. For this reason, it is possible to apply a greater variety of information terminals 102 to the present image reading system, and the usability is improved.

### Third Embodiment

A third embodiment is different from the first and second embodiments in that, in the image reading method illustrated in FIG. 5, the information terminal 102 holds a part of the scanned image storage destination information in advance. Hereinafter, the different point of the third embodiment from the first and second embodiments is described.

In the third embodiment, the information terminal 102 holds a part of the scanned image storage destination information in advance, and in S511 in FIG. 5, the other part of the scanned image storage destination information is obtained from the reading apparatus 101. The part of the scanned image storage destination information held in advance by the information terminal 102 is the host name and the domain name of the server 103, for example. The other part of the scanned image storage destination information obtained by the information terminal 102 from the reading apparatus 101 is the reading apparatus-related information, the job ID, the file name of the scanned image, and the like, for example.

The information terminal 102 stores a program to generate the scanned image storage destination information by combining the part of the scanned image storage destination information held in advance and the other part of the scanned image storage destination information obtained from the reading apparatus 101. The program may be stored in the storage device 304 of the information terminal 102. After the information terminal 102 obtains the other part of the scanned image storage destination information from the reading apparatus 101 in S511, the CPU 301 of the information terminal 102 may read out the program from the storage device 304 onto the RAM 303 to execute. Specifically, the information terminal 102 generates the scanned image storage destination URL by combining the host name and the domain name of the server 103 stored in advance and the reading apparatus-related information, the job ID, the file name of the scanned image, and the like obtained from the reading apparatus 101. In S512, the information terminal 102 requests the server 103 to provide the scanned image based on the generated scanned image storage destination URL.

Alternatively, in S511, the information terminal 102 may receive information indicating that scanning is executed by the reading apparatus 101, instead of the scanned image storage destination information, from the reading apparatus 101. The information indicating that scanning is executed is a scanning execution log, for example. The information terminal 102 extracts the reading apparatus-related information, the job ID, the file name of the scanned image, and the like from the scanning execution log and combines the extracted information with the host name and the domain name of the server 103 stored in advance to generate the scanned image storage destination URL.

According to the present embodiment, with the information terminal 102 holding in advance a part of the scanned image storage destination information, it is possible to efficiently establish the data communication between the information terminal 102 and the reading apparatus 101.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to improve the usability in a case of downloading a scanned image, which is generated by a reading apparatus and uploaded to a server, to an information terminal.

This application claims the benefit of Japanese Patent Application No. 2025-036688, filed March 7, 2025, which is hereby incorporated by reference herein in its entirety.

What is claimed is:

1. An image reading system, comprising:
a reading apparatus configured to read an original document;
a server; and
an information terminal, wherein
the reading apparatus includes at least one memory and at least one processor which function as:
a first transmission unit configured to transmit a scanned image, which is obtained by reading the original document, to the server; and
a first saving unit configured to save storage destination information including information of a storage location of the scanned image in the server,
the information terminal includes at least one memory and at least one processor which function as:
a first obtaining unit configured to obtain the storage destination information saved in the first saving unit from the reading apparatus; and
a second obtaining unit configured to obtain the scanned image from the server based on the storage destination information obtained by the first obtaining unit, and
the reading apparatus transmits the storage destination information of the scanned image to the information terminal in a case where a request for the storage destination information of the scanned image is received from the information terminal.

2. The image reading system according to claim 1, wherein
the reading apparatus can execute reading of the original document and saving of the storage destination information regardless of an activation state of the information terminal.

3. The image reading system according to claim 1, wherein
the at least one memory and the at least one processor of the information terminal further function as:
a second transmission unit configured to repeatedly transmit the request for the storage destination information to the reading apparatus on a regular basis.

4. The image reading system according to claim 3, wherein
the second transmission unit performs the request for the storage destination information repeatedly in a case where predetermined setting is performed.

5. The image reading system according to claim 1, wherein
the second obtaining unit obtains the scanned image from the server based on the storage destination information by downloading.

6. The image reading system according to claim 1, wherein
the at least one memory and the at least one processor of the reading apparatus further function as:
an auto-power-off control unit configured to automatically turn off the power in a case where a certain time has elapsed in a predetermined state,
the auto-power-off control unit does not automatically turn off the power in a case where the storage destination information is saved in the first saving unit.

7. The image reading system according to claim 1, wherein
the at least one memory and the at least one processor of the reading apparatus further function as:
a discarding unit configured to discard the storage destination information saved in the first saving unit in a case where a request to discard the storage destination information is received from the information terminal.

8. The image reading system according to claim 1, wherein
the first obtaining unit obtains the storage destination information saved in the first saving unit in a case of successful user authentication.

9. The image reading system according to claim 1, wherein
the information of the storage location of the scanned image is a Uniform Resource Locator (URL).

10. The image reading system according to claim 9, wherein
the at least one memory and the at least one processor of the information terminal further function as:
a second saving unit in which a part of the URL indicating the storage location of the scanned image is saved in advance; and
a generating unit configured to obtain the other part of the URL from the reading apparatus and combine the other part with the part of the URL saved in the second saving unit to generate the URL.

11. The image reading system according to claim 1, wherein
the at least one memory and the at least one processor of the reading apparatus further function as:
a first display control unit configured to display an access code, which allows for accessing the storage location of the scanned image in the server, on a display unit of the reading apparatus.

12. The image reading system according to claim 1, wherein
the at least one memory and the at least one processor of the information terminal further function as:
a second display control unit configured to display the obtained scanned image.

13. The image reading system according to claim 12, wherein
the second display control unit displays information indicating a storage location, in the information terminal, of the scanned image obtained by the second obtaining unit and displays the scanned image stored in the storage location in a case where an operation for the storage location by a user is accepted.

14. An image reading method executed in an image reading system including a reading apparatus configured to read an original document, a server, and an information terminal, the method comprising:
reading the original document by the reading apparatus;
transmitting a scanned image, which is obtained by reading the original document, to the server by the reading apparatus;
saving, by the reading apparatus, storage destination information including information of a storage location of the scanned image in the server;
obtaining, by the information terminal, the storage destination information saved in the saving from the reading apparatus; and
obtaining, by the information terminal, the scanned image from the server based on the storage destination information obtained in the obtaining the storage destination information, wherein
the reading apparatus transmits the storage destination information of the scanned image to the information terminal in a case where a request for the storage destination information of the scanned image is received from the information terminal.

15. A reading apparatus communicable with a server and an information terminal, comprising:
at least one memory and at least one processor which function as:
a reading unit configured to read an original document;
a transmission unit configured to transmit a scanned image, which is obtained by reading the original document, to the server; and
a saving unit configured to save storage destination information indicating storage destination of the scanned image in the server, wherein
the storage destination information of the scanned image is transmitted to the information terminal in a case where a request for the storage destination information of the scanned image is received from the information terminal.

16. A non-transitory computer readable storage medium storing a program which causes a computer of a reading apparatus communicable with a server and an information terminal to execute:
reading an original document;
transmitting a scanned image, which is obtained by reading the original document, to the server;
saving storage destination information indicating storage destination of the scanned image in the server; and
transmitting the storage destination information of the scanned image to the information terminal in a case where a request for the storage destination information of the scanned image is received from the information terminal.
